(19) United States
(12) Patent Application Publication
(10) Pub. No.: US 2011/0272315 A1
(43) Pub. Date: Nov. 10, 2011

(54) METHOD AND KIT FOR PROVIDING A DECORATIVE COVER WITH IMPROVED COLORS AND TEXTURES FOR ELECTRONIC DEVICES

(76) Inventor: Patrick L. Dixon, Gold Canyon, AZ (US)

(21) Appl. No.: 13/027,832

(22) Filed: Feb. 15, 2011

Related U.S. Application Data
(60) Provisional application No. 61/312,014, filed on May 7, 2010.

(51) Int. Cl. B65D 85/30; B05D 3/12

(52) U.S. Cl. 206/449; 427/289

(57) ABSTRACT

A kit is provided for use by an end user to apply a protective cover sheet material to an electronic device. The protective sheet includes visual enhancements for giving a unique look to the electronic device without altering the design and shape or form of the electronic device.

### CROSS-REFERENCE TO RELATED APPLICATIONS

This application claims the benefit of U.S. provisional application No. 61/312,014 filed May 7, 2010 which is incorporated herein in its entirety by reference.

### STATEMENT REGARDING FEDERALLY SPONSORED RESEARCH

Not Applicable

### BACKGROUND OF THE INVENTION

This disclosure relates to the development and application of decorative overlays to various electronic devices, and in particular to hand held mobile telephones and similar products. While the disclosure description of preferred embodiments is specific to such devices, those skilled in the art will recognize the wider applicability of the inventive concepts of the disclosure described hereinafter.

Decorative attachments for electronic devices are known in the art. Applicant's Assignee has manufactured and sold such products, a portion of which are described at http://phantomskinz.com/. In general, a protective wrap is attached to the electronic device by a suitable adhesive backed coating, which may or may not provide for air egress. Adhesive articles which provide air egress also are known in the art. Air egress is provided by supplying a route, such as areas of no initial adhesion for the air to flow out from under the material construction. One such method of construction and resultant article is described in U.S. Pat. Nos. 7,332,205 ('205) and 7,344,618 ('618). The invention in the '205 and '618 patents relates to an adhesive article comprising a face stock having a front surface and a back surface, a continuous layer of adhesive having an upper surface and a lower surface wherein the upper surface of the adhesive layer is adhered to the back surface of the face stock, and a plurality of spaced-apart non-adhesive material which is in contact with the lower surface of the adhesive layer wherein the adhesive article provides air egress.

Decorative articles are also known in the art. See for example U.S. Pat. No. 6,364,992 ('992) which provides a decorative sheet characterized in that the sheet comprises a thermoplastic resin layer (A), an adhesive layer containing a luster pigment (B) and a transparent or translucent thermoplastic resin layer (C) laminated in the ABC order mentioned. At least one of the layers contained luster pigments.

In addition, particular decorative designs are disclosed in U.S. Pat. No. 5,804,285 ('285). The '285 patent relates to a decorative sheet having a solid appearance resembling that of natural wood or fabric and embossed wood grain or fabric texture surfaces which shows an improved lustrous pattern that varies depending on its orientation relative to a light source or direction of view, and a method for producing the same.

While the prior art works for its intended purposes, strictly adopting the teaching of the prior art to cell phones and related electronic devices, for example, does not give the dramatic visual effect obtained with the present disclosure.

### BRIEF SUMMARY OF THE INVENTION

In accordance with the present disclosure, generally stated, a method and product made by the process is disclosed, which provides taking a flexible substrate, with or without an air egress system in the adhesive side of the substrate, applying various colors/paint to the substrate, adding special effects to such base colors/paint via techniques using an air spray system or electro static to apply affected colors/paint to the flexible substrate. In post application of the coloring process, a further coat and/or coats of a color compatible top coat, which may or may not be Urethane based, is applied preferably via spray or an electro static device to further protect and enhance the colored/painted substrate. Flex agents may or may not be introduced into the post application process to maintain or increase the flexibility of the colored substrate. In the preferred method of this disclosure, the material is cut into preselected outlines corresponding to a particular electronic device and packaged in kit form for the intended user.

### BRIEF DESCRIPTION OF THE SEVERAL VIEWS OF THE DRAWINGS

In the accompanying drawings which form part of the specification:

FIG. 1 is a flow chart in which describes a method of construction in which the following steps are conducted:

Step 1 Provide a suitable adhesive backed substrate

Step 2 Clean substrate thoroughly with painting prep materials

Step 3 Mix “High Metallic” paints with reducers

Step 4 Spray high metallic color paint on the substrate

Step 5 Mix Urethane or equivalent “clear coat” with a flex agent(s) and harden to provide a clear coat material.

Step 6 Spray Clear-coat over the color.

Step 7 Dry

Step 8 Cut pattern designs to correspond to predetermined specific electronic devices.

Step 9 Package for end user

Step 10 End user apply pattern to the device;

FIG. 2a is one illustrative embodiment of parts for a packaged kit for end user use;

FIG. 2b is one illustrative embodiment of the packaging directions included for end user use; and

FIG. 2c is one illustrative embodiment of a personal electronic device following installation of the parts included in kit form for end user installation.

Corresponding reference numerals indicate corresponding parts throughout the several figures of the drawings.

### DESCRIPTION OF THE PREFERRED EMBODIMENT

The following detailed description illustrates the invention by way of example and not by way of limitation. This description will clearly enable one skilled in the art to make and use the invention, and describes several embodiments, adaptations, variations, alternatives and uses of the invention, including what I presently believe is the best mode of carrying out the invention.

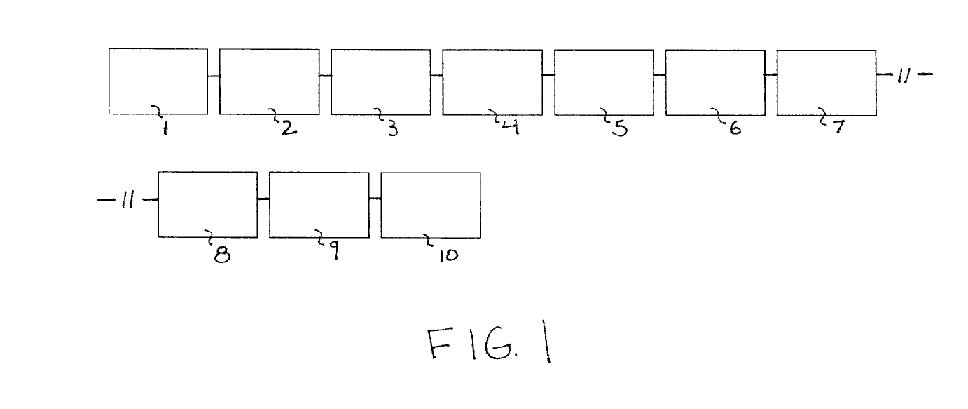

Referring now to FIG. 1, reference numeral 1 indicates the step of providing a suitable adhesive backed substrate. As will be appreciated by those skilled in the art, there are a number of substrates available and the choice of any particular substrate depends in part on the application to which the substrate will eventually become attached. Once chosen, the substrate is cleaned with in preparation for application of paint as illustratively shown by reference numeral 2.

An important feature of the present disclosure is the use of high metallic paint with reducers shown by reference numeral 3. The high metallic paint gives the material an enhanced visual look not obtained with prior art protective material methods of manufacture. In addition, the paint preferably is spray painted on the substrate to provide a uniform appearance also not present in prior art constructions and/or methods. I also have found that other paint formulations may be use to provide different dramatic looks to the material. Another aspect of the disclosure is the ability various materials such as simulated textured vinyl that looks and feels like Black Carbon Fiber embedded in the coating of the substrate. Other paint formulations are compatible with the broader aspects of the present disclosure.

Reference numerals 5, 6 and 7 refer to the application of a urethane or equivalent coating to the painted substrate. In step 5, the urethane is mixed with a flex agent which also is sprayed over the base materials and allowed to dry. The clear top coat also may have added visual enhancements such as ground or puried glass to provide enhanced sparkle.

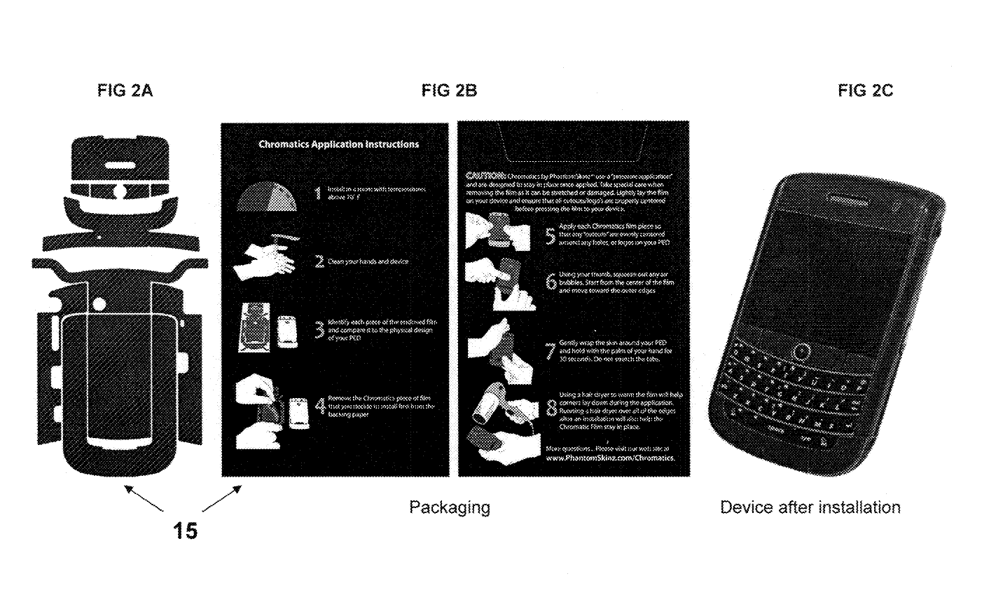

The material is then cut into predetermined pattern designs to correspond to specific electronic devices. Depending on the specific devices, the pattern designs can be rather complicated. One illustrative design is shown in FIG. 2. The particular application there shown is designed for the Blackberry tour model number 9630. “Blackberry” is a registered trademark of Research in Motion Limited. Regardless of the particular device, the design is sold in kit form, generally indicated by the numeral 15 in FIG. 2. The Kit 15 is packaged for end user application to the user's particular electronic device.

The material of the present disclosure has a number of advantages in use. There is no need, for example to remove the material when using a docking station. The material makes it easier to clean touch screens. The material does not alter the manufacturers look and/or shape and/or design with respect to the device, and the material does not void any manufacturer's warranty.

As various changes could be made in the above constructions without departing from the scope of the invention, it is intended that all matter contained in the above description or shown in the accompanying drawings shall be interpreted as illustrative and not in a limiting sense.

In view of the above, it will be seen that the several objects and advantages of the present invention have been achieved and other advantageous results have been obtained.

I claim as my invention:

1. A kit for use by an end user to apply a protective cover to an electronic device, comprising:
a first sheet of a resin film having a first back surface and a second front surface, the back surface being provided with an adhesive coating;
a color coat applied to the first surface, the color coat comprising a high metallic paint mixture and effect producing additives;
a protective coating applied to the color coat to provide a sheet material;
wherein the sheet material is cut and formed to provide a cover of a predetermined configuration; and
a package for the predetermined configuration enabling it to be sold in kit form for attachment of the cover by an end user.

2. The kit of claim 1 wherein the protective coat is urethane top coat.

3. The kit of claim 2 wherein the urethane is mixed with a flex agent.

4. The kit of claim 3 including a clear top coat.

5. The kit of claim 4 wherein the clear top coat includes at least one visual enhancement.

6. The kit of claim 5 wherein the visual enhancement is ground glass.

7. The kit of claim 5 wherein the substrate has the appearance of black carbon fiber embedded in it.

8. A method of providing a sheet material for use in a kit by an end user for applying a protective sheet to an electronic device, comprising:
providing a suitable adhesive backed substrate ;
cleaning the non adhesive side of the substrate thoroughly with painting preparation materials;
mixing a high metallic paints including reducers;
spraying high metallic color paint on the substrate;
mixing a urethane or equivalent clear coat including a flex agent(s);
applying the clear coat;
spraying clear coat over the color layer;
drying the combination;
cutting pattern designs to correspond to a predetermined specific electronic device; and
packaging the cut pattern with directions for use by an end user.

9. The method of claim 8 wherein the clear coat includes at least one visual enhancement.

10. The method of claim 9 wherein the visual enhancement is ground glass.

11. The method of claim 8 wherein the substrate has the appearance of carbon black fiber embedded in it.

12. A method of providing a protective cover for an electronic device, comprising:
providing an adhesive backed substrate;
cleaning the non adhesive side of the substrate in preparation for painting;
spraying a metallic color paint of the substrate;
spraying a clear coat over the color layer;
drying the combination;
cutting a preselected pattern design corresponding to a specific electronic device;
packaging the cut pattern design with directions for application to the electronic device by an end user.

13. The method of claim 12 wherein the clear coat includes at least one visual enhancement.

14. The method of claim 13 wherein the visual enhancement is ground glass.

15. The method of claim 12 wherein the substrate has the appearance of carbon black fiber embedded in it.
